(19) United States
(12) Patent Application Publication
(10) Pub. No.: US 2025/0348294 A1
(43) Pub. Date: Nov. 13, 2025

(54) SYSTEMS AND METHODS FOR SOFTWARE DEVELOPMENT AND OPERATIONS COMPILER

(71) Applicant: ServiceNow, Inc., Santa Clara, CA (US)

(72) Inventors: Varun Kumar Jayanti, Hyderabad (IN); Kiran Veera Venkata Mushnuri, Hyderabad (IN)

(21) Appl. No.: 18/659,297

(22) Filed: May 9, 2024

(51) Int. Cl. G06F 8/41

(52) U.S. Cl. CPC G06F 8/44

(57) ABSTRACT

A method is disclosed herein directed to identifying, using one or more rules, a particular programming language of a plurality of programming languages that is associated with a portion of code. The method also includes compiling the portion of code into one or more object files in the particular programming language that is associated with the portion of code and generating, via a development platform, an application using the one or more object files.

### TECHNICAL FIELD

The present disclosure relates generally to software development pipelines. Specifically, the present disclosure relates to software development pipelines that can support development of software code in multiple programming languages.

### BACKGROUND

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Furthermore, the IT infrastructure solutions may be used to streamline software development through use of development pipelines. Within the context of creation, generation, and implementation of development pipelines, multiple programming languages may be utilized in the development and deployment of an application. As such, building and deploying the application (e.g., program, blocks of code) include a respective deployment platform to support a corresponding programming language. Using and maintaining redundant parallel deployment platforms often result in inefficient use of computing resources. Further, using multiple platforms to develop and deploy an application that utilizes multiple programming language may result in errors if the multiple platforms do not interface effectively with one another.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure is directed to a development tool to streamline development pipelines for applications. The development tool constructs a development pipeline to support software development of one or more portions of code regardless of the programming language used during development. In this manner, the development tool may identify programming languages associated with portions of code, determine a compiler registry, determine a build registry, and output applications to existing development platforms of the enterprise. For example, the development tool is configured to identify a programming language of portions of code used to support an application. The development tool may identify the programming language based on one or more code repositories. In this manner, a rule-based program may access a portion of a code (e.g., file names, source code language) used to support the application and perform pattern matching to determine the programming language and/or a version of the programming language of the portions of code. The rule-based program may be based on one or more language identification definitions identified from the code repositories. Further, correction and/or update to programming languages may be implemented via a remote development key to support additional programming languages and/or new version of existing programming languages to maintain reliability of development platforms and applications across the enterprise. In this way, the development tool may use the remote development key to update new and/or existing applications to support programming language version updates within the single development platform. Further, the development tool may determine a build repository and/or a compiler repository to support generation of the application within the single development platform. In this manner, the portions of code may be compiled via an associated compiler registry and/or built via an associated build registry to output an executable application. Additionally, present embodiments include a graphical user interface (GUI) designed to present the development tool in a concise and organized format, which enables streamlining of software development into existing development platforms of the enterprise.

In an embodiment a method may include identifying, using one or more rules, a particular programming language of a plurality of programming languages that is associated with a portion of code, compiling the portion of code into one or more object files in the particular programming language that is associated with the portion of code, and generating, via a development platform, an application using the one or more object files.

In another embodiment, a system may include process circuitry and memory, accessible by the processing circuitry. The memory may store instructions that, when executed by the processing circuitry cause the processing circuitry to perform operations. The operations may include accessing, via a development tool, a portion of code, identifying, using one or more rules, a particular programming language of a plurality of programming languages that is associated with the portion of code, compiling the portion of code into one or more object files in the particular programming language that is associated with the portion of code, identifying, via the development tool, a build registry, wherein the build registry compiles the one or more object files and links the one or more object files to generate an executable application, and generating, via a development platform, an application using the one or more object files.

In a further embodiment, a non-transitory computer-readable storage medium may be provided that includes processor-executable routines that, when executed by processing circuitry, cause the processing circuitry to perform including identifying, using one or more rules, a particular programming language of a plurality of programming languages that is associated with a portion of code, compiling the portion of code into one or more object files in the particular programming language that is associated with the portion of code, and generating, via a development platform, an application using the one or more object files.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is schematic embodiment of a development tool, in accordance with aspects of the present disclosure;

FIG. 6 is schematic embodiment of a user interface of the development tool of FIG. 5, in accordance with aspects of the present disclosure;

FIG. 7 is a flow diagram of acts performed by the development tool of FIG. 5, in accordance with aspects of the present disclosure; and

FIG. 8 is a flow diagram of acts performed by the development tool of FIG. 5, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Systems and methods are disclosed herein that streamline development pipelines for applications. In this manner, a development tool may be used to support software deployment of one or more portions of code regardless of a programming language used during development. The development tool may automatically identify programming languages associated with portions of code, determine a compiler registry, determine a build registry, and output applications to existing development platforms of the enterprise. In one example, the development tool may be a rule-based program configured to determine the programming language associated with the portion of the code. In one such embodiment, the development tool may base the rule-based program on one or more language identification definitions developed based on a code repository. In this manner, the development tool may automatically identify the programming language of the portions of code and provide one or more associated registries for incorporation within a single development pipeline associated with the various software components of an enterprise IT infrastructure.

Accordingly, a development tool is disclosed herein to streamline development pipelines for applications. The development tool constructs a development pipeline to support software development of one or more portions of code regardless of the programming language used during development. In this manner, the development tool may identify programming languages associated with portions of code, determine a compiler registry, determine a build registry, and output applications to existing development platforms of the enterprise. For example, the development tool is configured to identify a programming language of portions of code used to support an application. The development tool may identify the programming language based on one or more code repositories. In this manner, a rule-based program may access a portion of a code (e.g., file names, source code language) used to support the application and perform pattern matching to determine the programming language and/or a version of the programming language of the portions of code. The rule-based program may be based on one or more language identification definitions identified from the code repositories. Being able to identify the programming language allows a single development pipeline to be used to reduce redundant program specific development pipelines running in parallel. Previously, multiple development pathways were used to account for difference in programming language used in different portions of code. Accordingly, as compared with previous techniques, the embodiments disclosed herein reduce computational expenses (e.g., reduced utilization of processing resources) associated with development.

Further, correction and/or update to programming languages may be implemented via a remote development key to support additional programming languages and/or new version of existing programming languages to maintain reliability of development platforms and applications across the enterprise. In this way, the development tool may use the remote development key to update new and/or existing applications to support programming language version updates within the single development platform. Further, the development tool may determine a build repository and/or a compiler repository to support generation of the application within the single development platform. In this manner, the portions of code may be compiled via an associated compiler registry and/or built via an associated build registry to output an executable application. Previously, additional development pipelines were generated upon use of additional programming languages. By updating the development tool via the remote development key additional programming languages may be incorporated into the single development pipeline. Additionally, present embodiments include a graphical user interface (GUI) designed to present the development tool in a concise and organized format, which enables streamlining of software development into existing development platforms of the enterprise.

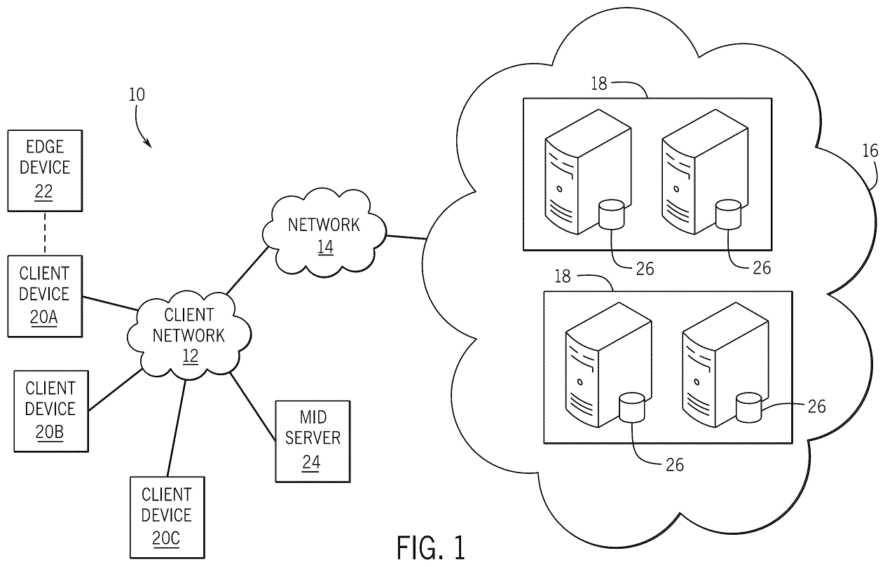

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, and 20C may be computing systems and/or other types of computing devices generally referred to as Internet of Things (IoT) devices that access cloud computing services, for example, via a web browser application or via an edge device 22 that may act as a gateway between the client devices 20A, 20B, and 20C and the platform 16. FIG. 1 also illustrates that the client network 12 includes an administration or managerial device, server, or software-implemented agent, such as a management, instrumentation, and discovery (MID) server 24 (such as a discovery server, more generally, in accordance with aspects of the present discussion) that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20A, 20B, and 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, and 20C via the client network 12 and network 14. The network hosting the platform 16 provides additional computing resources to the client devices 20A, 20B, and 20C and/or the client network 12. For example, by utilizing the network hosting the platform 16, users of the client devices 20A, 20B, and 20C are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

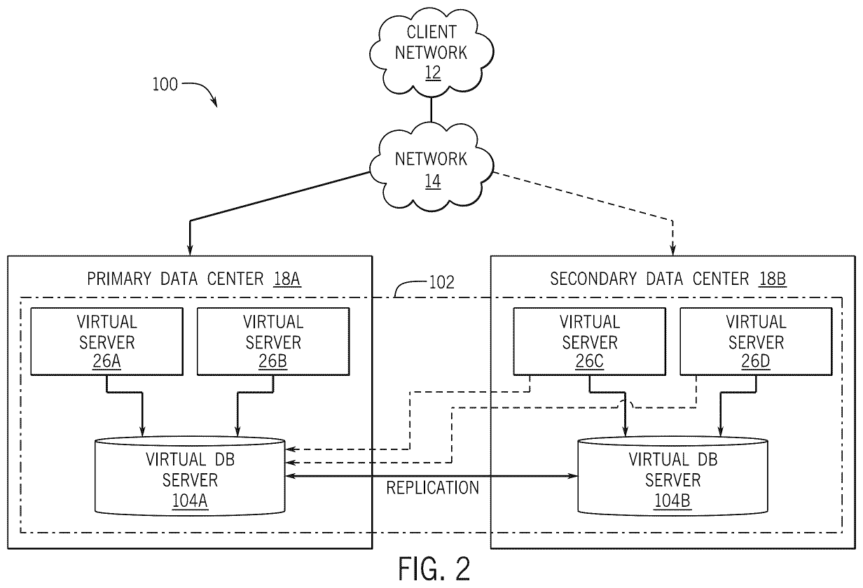

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

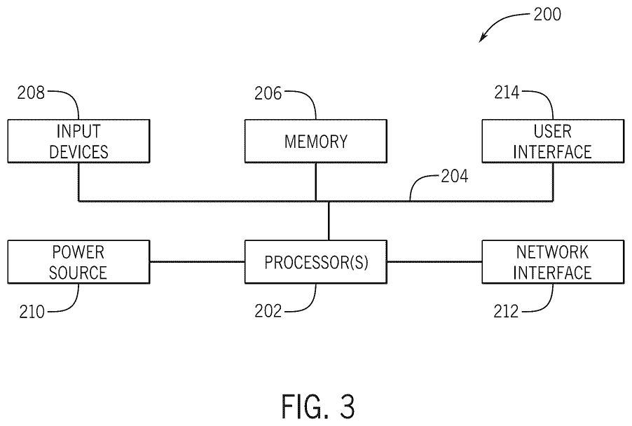

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

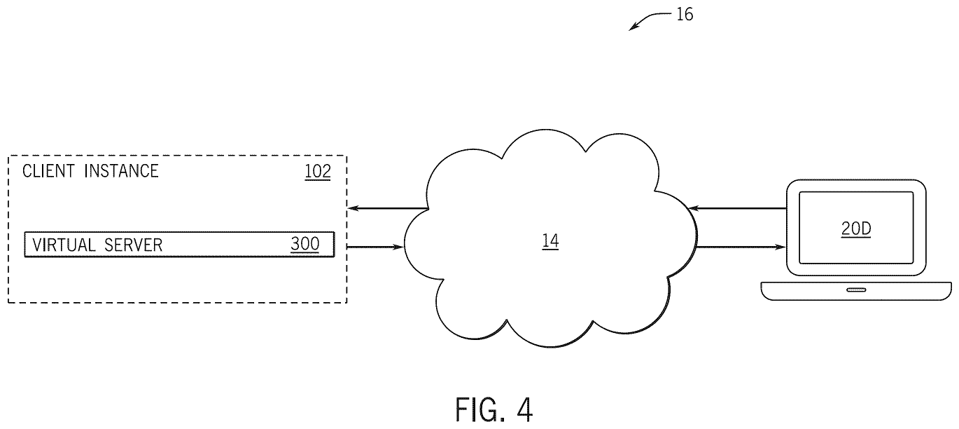

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

In some embodiments, a development pipeline may be hosted by the client instance 102. The development pipeline may be used to support software deployment of one or more portions of code regardless of a programming language used during development. The client instance 102 hosting the development pipeline may be accessible via the client device 20. In this manner, a development tool may automatically identify programming languages associated with portions of code, determine a compiler registry, determine a build registry, and output applications to existing development platforms of the enterprise within the cloud provide infrastructures of the enterprise.

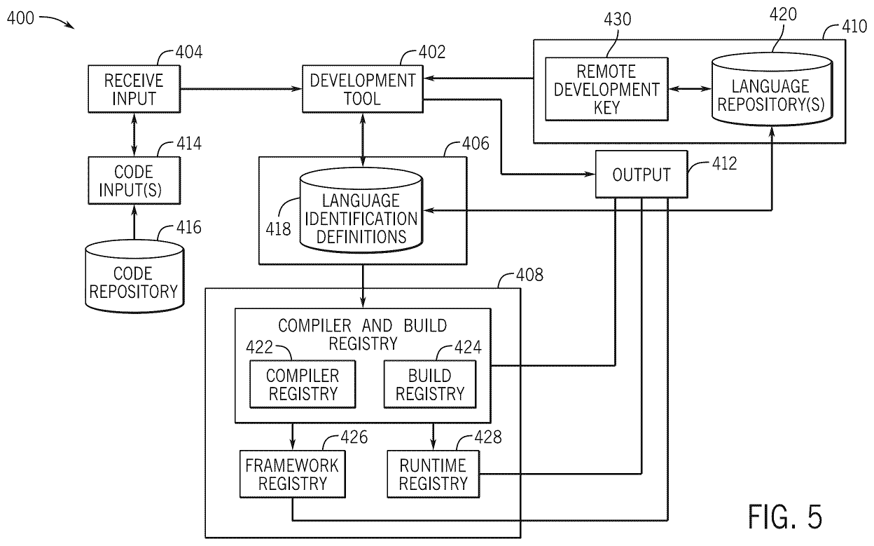

With this in mind, FIG. 5 is a schematic illustrating a portion of a development pipeline 400 (e.g., a development platform) to be utilized within an enterprise. The development pipeline 400 includes a development tool 402 that may be used to support software development of one or more portions of code regardless of programming language. For example, the development tool 402 may be accessible via a client device. Specifically, the client device may be configured to display a graphical user interface (GUI) that displays information and receives inputs that command the development tool 402 to take certain actions during software development. The development tool 402 streamlines design, deployment, and maintenance of applications across the enterprise within a single development platform. As shown, the development pipeline 400 may include one or more stages. It should be noted, that the illustrated stages are provided as examples and more, fewer, or different stages may be included in the development pipeline 400. As shown, the development pipeline 400 may include an input stage 404, an identification stage 406, a registry stage 408, a maintenance stage 410, and an output stage 412. The input stage 404 is initiated upon receiving one or more code inputs 414. The code inputs 414 may include one or more portions of code generated during sourcing, building, testing, deployment, and/or updating software (e.g., an application, a portion of an application, an update to an application and the like).

In some embodiments, the code inputs 414 may be acquired from a code repository 416. The code repository 416 may include a shared version control repository including code associated with projects within the development pipeline 400. In this way, the code repository 416 may acquire and/or integrate code changes from one or more developers working concurrently and/or consecutively within the development pipeline 400. The code inputs 414 may be acquired by the development tool 402 during the input stage 404 based on a request from the development tool 402, automatic delivery, triggered delivery (e.g., time based, threshold based), manual intervention, and the like. For example, in certain embodiments, the code inputs 414 may be acquired by the development tool 402 within the context of an automated development pipeline (e.g., continuous integration, continuous delivery, continuous deployment). In this manner, the code inputs 414 may be received by the development tool 402 automatically based on delivery of code modifications and/or additions to various environments of the development pipeline 400 for testing, staging, and/or deployment implementation. Additionally and/or alternatively, the code inputs 414 may be received by the development tool 402 based on a controlled release process to ensure any potential errors associated with the code repository 416 may be identified before the code inputs 414 are built and/or deployed.

In some embodiments, the input stage 404 is advanced to the identification stage 406 based on receiving the code inputs 414. The identification stage 406 may identify a particular programming language associated with the code inputs 414. Identification of the particular programming language may be assessed using a rule-based program or routine configured to apply one or more rules. The rules may be generated based on one or more language identification definitions 418. As shown, the language identification definitions 418 may acquire one or more inputs from the language repositories 420 and store the one or more inputs in a database. In some embodiments, the inputs from the language repositories 420 may include parameters associated with one or more programming languages. For example, the language repositories 420 may store parameters that may be used to identify a programming language of a piece of code and/or distinguish programming languages from one another (e.g., distinguish a first programming language from a second programming language). The development tool 402 may generate the language identification definitions by associating the particular features of each programming language using a programming language identifier. The programming language identifier may include a name, a version, or a combination thereof associated with a particular programming language. The language identification definitions 418 may use the programming language identifier to associate one or more parameters to the particular programming language.

In some embodiments, the language identification definitions 418 may be used to generate one or more rules to identify a particular programming language. For example, the language identification definitions 418 may include parameters associated with a header, a file extension, one or more common file names, a configuration file, a configuration line, syntax, commands, regular expressions (regexes), and the like of the particular programming language (e.g., JavaScript, Java, Python, HyperText Markup Language (HTML), Structured Query Language (SQL), C#, etc.). Further, in some embodiments, one or more portions of the header, the file extension, file names, the configuration file, and/or the configuration line may include ISO (International Organization for Standardization) standards for programming languages. ISO standards may include a standard header template that may be associated with a particular programming language and/or the programming language identifier. In this manner, the language identification definitions 418 may associate specific formats, syntaxes, strings, and/or data structures of code inputs 414 with particular programming languages.

In certain embodiments, the rules of the rules-based program may be defined using the particular parameters and/or the programming language identifier stored within the language identification definitions 418. The rules may be based on pattern matching between the language identification definitions 418 and the code inputs 414. For example, the language identification definitions 418 may include portions of a header of a particular programming language. The portions of the header may be matched a particular programming language identifier. In this manner, the development tool 402 may provide the name and/or the version associated with the programming language. As such, the programming language of the code inputs 414 may be determined based on similarities between the language identification definitions 418 and one or more portions of the code inputs 414. For example, a header of a portion of code associated with the code inputs 414 may include one or more parameters included in the ISO standards for programming languages such as a standard header template that may be associated with a particular programming language via the programming language identifier.

In certain embodiments, the rules-based program may include a list of the rules used to identify the programming language of the code inputs 414. The list may be prioritized (e.g., ranked) in order of processing time, historical identification success rate, or any suitable priority. For example, the list may include one or more priorities that may be used to determine a procedure for identifying the programming language of the code inputs 414. For example, a first priority may determine if the code inputs 414 include a header that may include one or more of the language identification definitions 418. A second priority may include analyzing one or more execution files to determine if one or more file extensions associated with a particular programming language may be discovered. In this manner, the rules-based program may continue through the list of rules until the programming language of the code inputs 414 is identified. It should be noted, the rules-based program may perform all of the rules, a portion of the rules, and/or a subset of the rules of the rules-based program during identification of the programming language of the code inputs 414. For example, as rules are applied, a confidence score may be calculated that indicates the algorithms confidence that a portion of code is in a particular language. If, during application of the rules, the confidence score is greater than some threshold (e.g., 98% confident that a portion of code is in python), it may be assumed that the portion of code is of a particular language and the process may be stopped before all of the rules are applied. Additionally and/or alternatively, the identification stage 406 may identify a plurality of programming languages associated with the code inputs 414. As such, the identification stage 406 may provide the identified programming language associated with a portion of the code input.

In some embodiments, the identification stage 406 is advanced to the registry stage 408. The development tool 402 may identify one or more registries for use in software development and/or deployment of the code inputs 414. In this manner, the development tool 402 may avoid operating parallel development platforms specific to programming languages by identifying one or more particular registries that may compile, build, and/or execute the portions of code from the code repository 416 within the development platform. The registry stage 408 may identify a compiler registry 422, a build registry 424, a framework registry 426, a runtime registry 428, or a combination thereof based on the identified programming language of the code inputs 414.

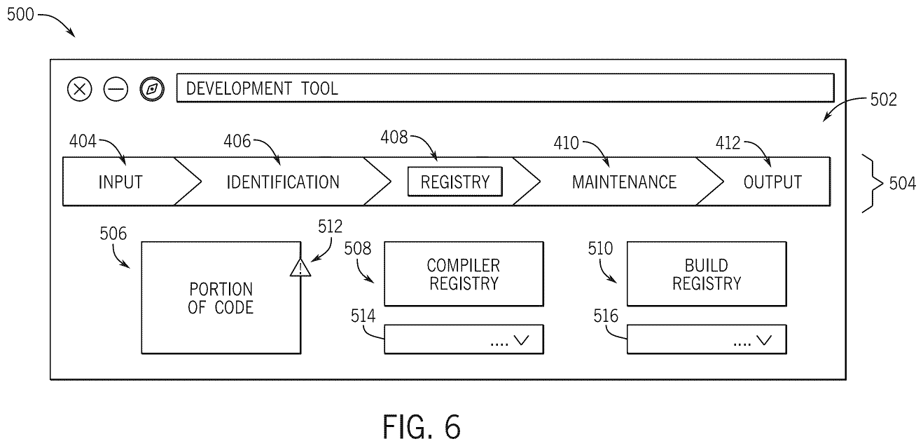

In some embodiments, the development tool 402 may identify the compiler registry 422 from a library of available compiler registries based on the identified programming language of the code inputs 414. The identified compiler registry 422 may be used to translate the identified programming language of the code inputs 414 to an object code, a machine code, a bytecode, a preferred programming language, and/or additional target languages. In some embodiments, when more than one programming languages are identified within the code inputs 414 one or more additional compiler registries may be identified to compile a portion of the code inputs 414. In certain embodiments, the development tool 402 may identify the build registry 424 from a library of available build registries based on the identified programming language of the code inputs 414. In this manner, the identified build registry 424 may be used to translate, process, test, configure dependencies, and/or output object files based on the code inputs 414. In some embodiments, the build registry 424 may be used to combine one or more code inputs (e.g., one or more source files) and/or one or more portions of the code associated with different processing languages. It should be noted, that the development tool 402 may identify the compiler registry 422, the build registry 424, or a combination thereof. Additionally and/or alternatively, the development tool 402 may identify a plurality of compiler registries 422 and/or a plurality of build registries 424 that may be used within the development pipeline 400. As such, the development tool 402 may prompt, via a user interface, inputs selecting a particular compiler registry and/or build registry as will be discussed further in regards to FIG. 6.

In some embodiments, the development tool 402 may identify the framework registry 426 and/or the runtime registry 428 associated with the identified compiler registry 422 and/or the identified build registry 424. That is, the framework registry 426 and/or the runtime registry 428 may be identified based registries used to compile and/or build the code inputs 414. In this way, the framework registry 426 and/or the runtime registry 428 may be selected based on integration with the output (e.g., object file, byte code, machine code) of the compiler registry 422 and/or the build registry 424. The framework registry 426 may include a self-hosted registry (e.g., hosted internally to the enterprise). The framework registry 426 may acquire an output of the compiler registry 422 and/or the build registry 424. In this manner, a particular framework registry 426 may be identified for use in the output stage 412. It should be noted that in some embodiments, the development tool 402 may identify a single registry that may compile, build, and deploy the portion of code acquired by the code inputs 414.

In some embodiments, the development tool 402 is advanced to the maintenance stage 410. It should be noted, that the maintenance stage 410 may occur after the output stage 412. That is, the maintenance stage 410 may be continuously updating the development tool 402. In this manner, the development tool 402 may be updated to identify one or more additional programming languages, one or more programming language versions, updates to programming languages (e.g., corrections, additions), or a combination thereof. In certain embodiments, the maintenance stage 410 may include a remote development key 430. The remote development key 430 may acquire updates to the language repositories 420. In this manner, the development tool 402 may update the language identification definitions 418 and/or the rule-based program based on the remote development key 430. In this manner, the remote development key 430 may support additional programming languages and/or new version of existing programming languages of the language repositories 420. For example, a new version of a particular programming language may be released. Therefore, to maintain reliability of the development pipeline 400, the remote development key 430 may acquire inputs associated with the new version of the particular programming language. In this manner, the development tool 402 may identify code inputs 414 associated with the new version of the programming language. In this manner, applications across the enterprise may be supported by the development tool 402 through identification of the programming language used in the code inputs 414. As such, developers may use various versions, various programming languages, or a combination thereof. The development tool 402 may use the remote development key 430 to update new and/or existing applications to support programming language version updates within a single development platform of the enterprise.

In certain embodiments, the development tool 402 is advanced to the output stage 412. The output stage 412 may include outputting one or more identified registries (e.g., compiler registry 422, build registry 424, framework registry 426, runtime registry 428), output files from the identified registries, and/or deploying applications via the identified registries. The identified registries may be output to the development pipeline 400 for compilation, building, and/or deployment at future stages of the development pipeline 400. Additionally and/or alternatively, the object files (e.g., machine code, bytecode, additional data, metadata) may be output by the development tool 402. The object files may be generated by the compiler registry 422, the build registry 424, or a combination thereof. The object files may be output by the development tool 402 to the development pipeline. In some embodiments, the object files may be integrated with additional object files to generate an application. Additionally and/or alternatively the development tool 402 may be used to generate the application.

With this in mind, in some embodiments, the framework registry 426 may acquire the output files from the compiler registry 422 and/or the build registry 424. In this manner, the framework registry 426 may be used to design, develop, and/or test an application associated with the portion of the code (e.g., code inputs 414) acquired from the code repository 416. The framework registry 426 may be hosted internally to design, develop, debug, and/or test the application before deployment. Additionally and/or alternatively, the runtime registry 428 may be publicly hosted via the cloud computing system 10. In this way, the runtime registry 428 may deploy the application associated with the portion of the code. As such, the application may be accessible by the client network 12 and/or the cloud-based platform 16 of the enterprise, such that client devices can download or otherwise access the application.

FIG. 6 is a schematic embodiment of a user interface 500 of the development tool 402. The user interface 500 may display a screen having a dashboard 502 (e.g., command center) that may be used to identify programming languages within the development pipeline 400. In this manner, the development tool 402 provides centralized feedback to one or more users of the dashboard 502. The dashboard 502 may include various widgets (e.g., user interface widgets) providing alerts, notifications, status updates, user requests, value assessments and the like. Further, the development tool 402 may be used to direct various stages (e.g., the input stage 404, the identification stage 406, the registry stage 408, the maintenance stage 410, the output stage 412) as discussed above with reference to FIG. 5.

In some embodiments, the various widgets of the dashboard 502 include one or more of a status bar widget 504, a code input widget 506, a compiler registry widget 508, and a build registry widget 510. The status bar widget 504 may display a plurality of stages of the development tool 402. Each stage of the development tool 402 may be selected to generate a page of the user interface 500. In some instances, selection of a particular stage may generate a dialog box within the user interface 500. In the illustrated embodiment, the registry stage 408 is selected. In this manner, the code input widget 506, the compiler registry widget 508, and the build registry widget 510 are displayed. In certain embodiments, the code input widget 506 may include a portion of code. The portion of code may be acquired as the code inputs 414 from the code repository 416. In some embodiments, the code input 414 may be directly acquired via the user interface 500. That is, the user may input the portion of code, a file path to the portion of code, and/or an additional reference to the portion of code via the code input widget 506. As shown, the code input widget 506 may include one or more notification icons 512 indicative of an error, a missing file path, missing parts, and the like for a particular portion of code. For example, notifications related to the particular portion of code may be displayed to the user on the dashboard 502 upon selection of the notification icon 512 indicating that a file path input to the code input widget 506 may not be found.

The compiler registry widget 508 and/or the build registry widget 510 may provide the user with one or more registries based on the identified programming language of the portion of code input into the code input widget 506. For example, in some embodiments, the development tool 402 may identify one or more compiler registries 422 that may be used to compile the portion of code. As such, a dropdown list 514 may be provided to the user via the user interface 500 to prompt the user to select a preferred compiler registry. The preferred compiler registry may be used by the development tool 402 to compile the portion of code and output one or more object files.

In certain embodiments, the development tool 402 may identify one or more build registries 424 that may be used to build the portion of code. As such, a dropdown list 516 may be provided via the user interface 500 to prompt selection of a preferred build registry. The preferred build registry may be used by the development tool 402 to build the portion of code and output one or more object files.

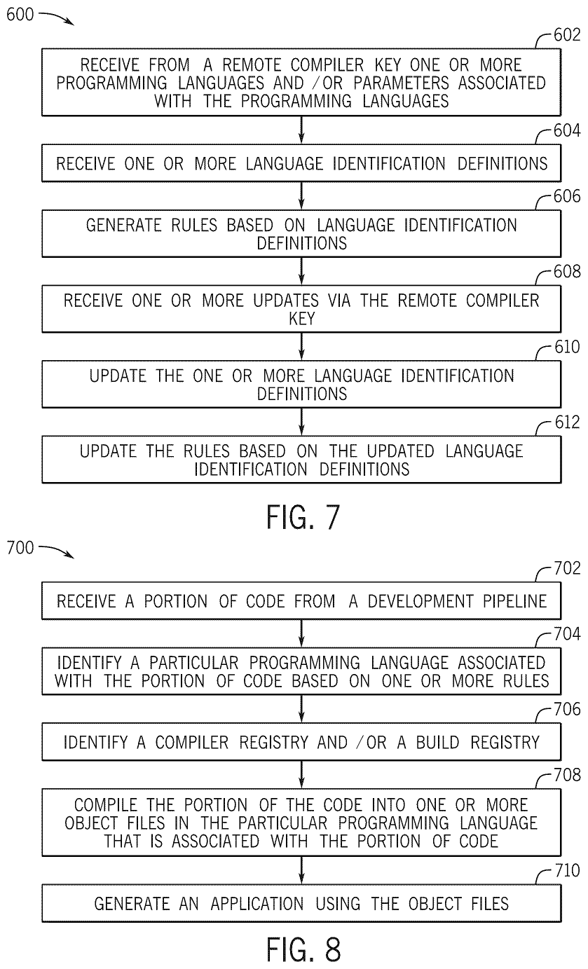

Referring now to FIG. 7, a development tool may perform a process 600 for generating and/or updating one or more rules for use in identification of one or more processing languages associated with a portion of code within a development pipeline. The process 600 may be performed by a computing device or controller disclosed above with reference to FIG. 1 or any other suitable computing device(s) or controller(s). Furthermore, the blocks of the process 600 may be performed in the order disclosed herein or in any suitable order. For example, certain blocks of the process may be performed concurrently. In addition, in certain embodiments, at least one of the blocks of the process 600 may be omitted.

At block 602 of the process 600, the development tool receives one or more programming languages from a remote compiler key. The remote compiler key may receive inputs related to programming languages from a language repository, a code repository, one or more manual inputs, and the like. The inputs may include one or more parameters that may be associated with a particular programming language. For example, the parameters may include a portion of a header unique to the particular programming language. The parameters may include information related to a form of syntax used in the particular programming language, a file extension associated with the particular programming language, and the like. It should be noted, that in some embodiments, the development tool may receive the programming languages and/or the one or more parameters associated with the programming languages directly from the one or more language repositories.

At block 604 of the process 600, the development tool may receive one or more language identification definitions based on the programming languages and/or the parameters associated with the programming languages. In some embodiments, the development tool may generate the language identification definitions by associating the particular features of each programming language using a programming language identifier. The programming language identifier may be used to identify one or more language identification definitions as being specific to particular programming languages. For example, the programming language identifier may include a name, a version, or a combination of the two corresponding to a specific programming language. In this manner, the language identification definitions may be associated with the name and/or the version of the programming language.

With the foregoing in mind, at block 606, the language identification definitions are used to generate one or more rules. In some embodiments, the rules may be stored in a rule-based program in memory of the development tool. The rule-based program may be used to identify programming languages associated with portions of code received as inputs by the development tool as will be discussed further in reference to FIG. 8. The rules may be generated to assess pattern matching between the language identification definitions and code received by the development tool. Upon generation of the rules the development tool 402 may be used within the development pipeline.

In some embodiments, at block 608, the development tool may receive one or more updates via the remote compiler key. The remote compiler key may acquire corrections and/or updates to programming languages. Additionally and/or alternatively the remote compiler key may acquire one or more additional programming languages, one or more additional versions of programming languages, and the like. In this manner, the development tool may be updated to maintain reliability of the development pipeline and support applications across the enterprise. At block 610, the development tool may update the one or more language identification definitions based on the corrections and/or updates acquired by the remote compiler key. For example, an additional programming language may be added to the remote key compiler via the language repositories. As such, the development tool may generate an additional programming language identifier associated with the additional language. The development tool may generate additional language identification definitions. The additional language identification definitions may be associated with the additional programming language identifier. At block 612, the development tool may update the rules and/or the rules-based program based on the updates to the language identification definitions. The rules may be updated to include the additional programming language identifier and associated additional language identification definitions. In this manner, the rules may be updated to streamline and integrate additional programming languages within the development pipeline without need for additional development pipelines specific to programming languages to be run in parallel.

Being able to generate rules and to update the rules used to identify particular programming languages associated with portion of code acquired by the remote development key allows for integration of various programming languages into the single development pipeline. Previously, additional development pipelines may be generated upon use of additional programming languages. By updating the development tool via the remote development key additional programming languages may be incorporated into the single development pipeline. These techniques result in streamlined incorporation of multiple portions of code with various programming languages used within the single development pipeline to provide efficient software development, deployment, and maintenance, as well as more efficient use of available computational resources.

Referring now to FIG. 8, a development tool may perform a process 700 for identifying one or more processing languages associated with a portion of code within a development pipeline. The process 700 may be performed by a computing device or controller disclosed above with reference to FIG. 1 or any other suitable computing device(s) or controller(s). Furthermore, the blocks of the process 700 may be performed in the order disclosed herein or in any suitable order. For example, certain blocks of the process may be performed concurrently. In addition, in certain embodiments, at least one of the blocks of the process 700 may be omitted.

At block 702 of the process 700, the development tool receives a portion of code. The portion of code may be accessed from a code repository of a development pipeline. In some embodiments, the portion of code may be accessed via an application development pipeline. The portion of code may be acquired during one or more stages of the development pipeline (e.g., the application development pipeline) such as design, development, testing, staging, deployment of an application. The code repository may store code associated with the application. Developers may input portions of code and/or update portions of code within the development pipeline. In some instances, codes input to the code repository may include one or more programming languages. To integrate the acquired code within the development pipeline, the development tool may be used to identify the programming language associated with the acquired portion of the code.

With this in mind, at block 704 of the process 700, the development tool identifies a particular programming language associated with the portion of the code based on one or more rules. The one or more rules may be generated according to the process 600 outlined in FIG. 7. In certain embodiments, the rules may prompt the development tool to find a particular file within the portion of the code. For example, the rules may search the portion of the code for a header file. As different programming languages store header files in particular formats, the rules may include one or more commands to direct the development tool to search for one or more file extensions associated with programming languages stored in memory within the rules-based program. In embodiments in which the development tool locates the header file, the rules may direct the development tool to search for a particular string of code associated with a name and/or a version of the programming language within the header file. The language identification definitions may include portions of a header of a particular programming language. The portions of the header may be matched to a particular programming language identifier. In this manner, the development tool may output the name and/or the version of an identified programming language. Additionally and/or alternatively, the development tool may proceed to one or more additional rules to verify the identified programming language. Further, in some embodiments, the header file may not be found by the development tool. As such, the development tool may proceed to identify the programming language associated with the portion of code using one or more additional rules within the rules-based program.

At block 706 of the process 700, the development tool may identify a compiler registry and/or a build registry based on the identified programming language associated with the portion of the code. The compiler registry and/or the build registry may be identified based on compatibility with the identified programming language. That is, registries (e.g., compiler registries, build registries, framework registries, runtime registries) may be able to compile, build, and deploy applications of particular programming languages. For example, a first compiler registry may be able to compile code associated with a first programming language. A second compiler registry may be able to compile code associated with a second programming language. As such, the development tool may identify specific registries compatible with the identified programming language. It should be noted, that in some embodiments, one or more registries may be identified to be compatible with the identified programming language. As such, the development tool may query a user of the development pipeline and/or select a preferred registry previously selected by the user.

Upon identification of the compiler registry and/or the build registry that may be compatible with the identified programming language of the portion of the code. At block 708 of the process 700, the development tool may compile the portion of the code into one or more object files in the identified programming language (e.g., a particular programming language) that is associated with the portion of the code. In some embodiments, an identified compiler registry may be fed the portion of the code. The identified compiler registry may compile the code of the identified programming language. Compilation of the code translates the identified programming language into the object files. The object files may include files in a machine language (e.g., binary code) that may be used to deploy the application. The object files may be output by the development tool.

At block 710 of the process 700, the development tool generates an application with the object files. The development tool may link the object files to generate an executable application. In some embodiments, the application may be generated via a runtime registry and/or a framework registry. Additionally and/or alternatively, the application may be hosted by a cloud computing service to provide a service to users within the enterprise. It should be noted, that in some instances the object files may be directed to additional stages within the development pipeline. As such, the object files may be added to a second portion of code associated with development of the application. In certain embodiments, the object files may be directed towards a particular branch (e.g., portion) of the development pipeline. Regardless, the development tool enables multiple programming languages to be identified and integrated within the single development pipeline.

Previously, multiple development pathways were used to account for difference in programming language used in portions of code. Use of the development tool identifies particular programming language used in portions of code, identifies registries associated with the particular programming language, and compiles portions of code to output object files associated with the portions of code in the particular programming language. Being able to identify the programming language allows a single development pipeline to be used to support software development. Accordingly, redundant pipelines specific to programming languages are reduced.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method comprising:
identifying, using one or more rules, a particular programming language of a plurality of programming languages that is associated with a portion of code;
compiling the portion of code into one or more object files in the particular programming language that is associated with the portion of code; and
generating, via a development platform, an application using the one or more object files.

2. The method of claim 1, comprising accessing the portion of code within an application development pipeline.

3. The method of claim 1, comprising applying the one or more rules to identify, via a development tool, a particular programming language, of a plurality of programming languages, of the portion of code within the development platform.

4. The method of claim 3, wherein the development tool is configured to:
receive one or more additional portions of code in the plurality of programming languages from a code repository; and
generate one or more additional rules based on one or more language identification definitions; and
store the one or more additional rules in memory with the one or more rules.

5. The method of claim 4, wherein applying the one or more rules comprises:
identifying a pattern between the one or more language identification definitions and the portion of code within the development platform; and
analyzing the pattern to determine the programming language of the portion of code.

6. The method of claim 4, comprising:
updating, via a remote development key, the one or more language identification definitions, wherein the remote development key comprises indications of one or more additional programming languages, one or more programming language versions, or a combination thereof.

7. The method of claim 1, comprising:
identifying a compiler registry, wherein the compiler registry is configured to compile the portion of source code into the one or more object files in the identified programming language.

8. The method of claim 7, comprising:
identifying a build registry, wherein the build registry compiles the one or more object files and links the one or more object files to generate an executable application.

9. The method of claim 1, wherein the using the one or more rules comprises pattern matching a portion of a header associated with the portion of code and one or more language identification definitions.

10. The method of claim 9, wherein the language identification definitions comprise one or more programming language identifiers associated with a particular programming language.

11. A system, comprising:
processing circuitry; and
memory, accessible by the processing circuitry, the memory storing instructions that, when executed by the processing circuitry, causes the processing circuitry to perform operations comprising:
accessing, via a development tool, a portion of code;
identifying, using one or more rules, a particular programming language of a plurality of programming languages that is associated with the portion of code;
compiling the portion of code into one or more object files in the particular programming language that is associated with the portion of code;
identifying, via the development tool, a build registry, wherein the build registry compiles the one or more object files and links the one or more object files to generate an executable application; and
generating, via a development platform, an application using the one or more object files.

12. The system of claim 11, wherein the operations comprise:
receiving one or more additional portions of code in the plurality of programming languages from a code repository; and
generating one or more additional rules based on one or more language identification definitions; and
storing the one or more additional rules in memory with the one or more rules.

13. The system of claim 12, wherein applying the one or more of rules comprises:
identifying a pattern between the one or more language identification definitions and the portion of code within the development platform; and
analyzing the pattern to determine the programming language of the portion of code.

14. The system of claim 12, wherein the operations comprise:
updating, via a remote development key, the one or more language identification definitions, wherein the remote development key comprises indications of one or more additional programming languages, one or more programming language versions, or a combination thereof.

15. The system of claim 11, wherein the operations comprise:
identifying, via the development tool, a compiler registry, wherein the compiler registry is configured to compile the portion of source code into the one or more object files in the identified programming language.

16. The system of claim 11, wherein the using the one or more rules comprises pattern matching a portion of a header associated with the portion of code and one or more language identification definitions.

17. A non-transitory computer-readable storage medium, comprising processor-executable routines that, when executed by a processor, cause the processor to perform operations comprising:
accessing, via a development tool, a portion of code;
identifying, using one or more rules, a particular programming language of a plurality of programming languages that is associated with the portion of code;
compiling the portion of code into one or more object files in the particular programming language that is associated with the portion of code; and
generating, via a development platform, an application using the one or more object files.

18. The non-transitory computer-readable storage medium of claim 17, wherein the operations comprise:
identifying a pattern between one or more language identification definitions and the portion of code within the development platform; and
analyzing the pattern to determine the programming language of the portion of code.

19. The non-transitory computer-readable storage medium of claim 17, wherein the operations comprise:
identifying a build registry, wherein the build registry compiles the one or more object files and links the one or more object files to generate an executable application.

20. The non-transitory computer-readable storage medium of claim 17, wherein the operations comprise:
identifying a compiler registry, wherein the compiler registry is configured to compile the portion of source code into the one or more object files in the identified programming language.
